(19) United States
(12) Patent Application Publication
(10) Pub. No.: US 2022/0411080 A1
(43) Pub. Date: Dec. 29, 2022

(54) DROGUE PARACHUTE SYSTEM FOR SPACECRAFT

(71) Applicant: AT SPACE PTY LTD, North Adelaide (AU)

(72) Inventor: Yen-Sen CHEN, North Adelaide (AU)

(21) Appl. No.: 17/355,176

(22) Filed: Jun. 23, 2021

(51) Int. Cl. B64D 17/80; B64D 17/38; B64D 17/52

(52) U.S. Cl. CPC B64D 17/80; B64D 17/38; B64D 17/52

(57) ABSTRACT

A drogue parachute system for a spacecraft includes a first parachute, a first set of connection lines, an extension device, a second set of connection lines, a second parachute and a third set of connection lines. Each connection line of the first set of connection lines includes two opposite ends respectively connected to the first parachute and the spacecraft. Each connection line of the second set of connection lines includes two opposite ends respectively connected to the extension device and the first parachute. Each connection line of the third set of connection lines includes two opposite ends respectively connected to the second parachute and the extension device.

### BACKGROUND

### Field of the Invention

The present invention relates to a spacecraft recovery technology, and more particularly to a drogue parachute system for a spacecraft.

### Description of Related Art

Conventional launch vehicles are designed to have their upper stage reenter the Earth atmosphere after launch vehicles deliver satellite payload into orbit. The upper stage is then burned away through the reentry flight because hypersonic flight speed and increasing air density led to extremely high heating rates. For spacecraft reentry and recovery operations for crew or payload return to Earth safely, heat shields designed to handle the aerothermodynamic effects are employed to pass through the reentry flight high-heating phase without damaging the payload and/or putting the crew at risk. Spacecraft and upper stage recovery technology present high added value to the overall space launch system.

### SUMMARY

One objective of the present invention is to provide a drogue parachute system for a spacecraft, and the drogue parachute system is capable of preventing the spacecraft from experiencing the aerothermal heat impact in the reentry flight of the spacecraft to the earth so that a safe and stable reentry flight is possibly achieved for spacecraft recovery.

Another objective of the present invention is to provide a drogue parachute system for a spacecraft, and the drogue parachute system is capable of inducing a safe and stable reentry flight by slowing down the spacecraft during the reentry flight.

To achieve the foregoing or other objectives, the present invention provides a drogue parachute system for a spacecraft according to an embodiment, and the drogue parachute system includes a first parachute, a first set of connection lines, an extension device, a second set of connection lines, a second parachute and a third set of connection lines. Each connection line of the first set of connection lines includes two opposite ends respectively connected to the first parachute and the spacecraft. Each connection line of the second set of connection lines includes two opposite ends respectively connected to the extension device and the first parachute. Each connection line of the third set of connection lines includes two opposite ends respectively connected to the second parachute and the extension device.

In some embodiment, a distance between a periphery of the first parachute in operation and the spacecraft is longer than a distance between a center of the first parachute in operation and the spacecraft.

In some embodiment, a distance between a periphery of the second parachute in operation and the spacecraft is shorter than a distance between a center of the second parachute in operation and the spacecraft.

In some embodiment, the extension device comprises an inner space for accommodating the second parachute and the third set of connection lines.

In some embodiment, the drogue parachute system further includes a housing for accommodating the first parachute, the first set of connection lines, the second set of connection lines, the extension device, the second parachute and the third set of connection lines.

In some embodiment, the second parachute and the third set of connection lines are released from the extension device after the extension device is pushed out from the spacecraft, and then the second set of connection lines, the first parachute and the first set of connection lines are released from the spacecraft.

In some embodiment, at least a part of the extension device is flexible.

In some embodiment, the first, second and third sets of connection lines are made of at least KEVLAR fiber.

In some embodiment, the second parachute is smaller than the first parachute.

### BRIEF DESCRIPTION OF THE DRAWINGS

After studying the detailed description in conjunction with the following drawings, other aspects and advantages of the present invention will be discovered:

FIG. 1 is a schematic diagram of a part of a drogue parachute system released from a spacecraft according to an embodiment of the present invention; and

FIG. 2 is a schematic diagram of the drogue parachute system of FIG. 1 fully released from the spacecraft according to an embodiment of the present invention.

### DETAILED DESCRIPTION

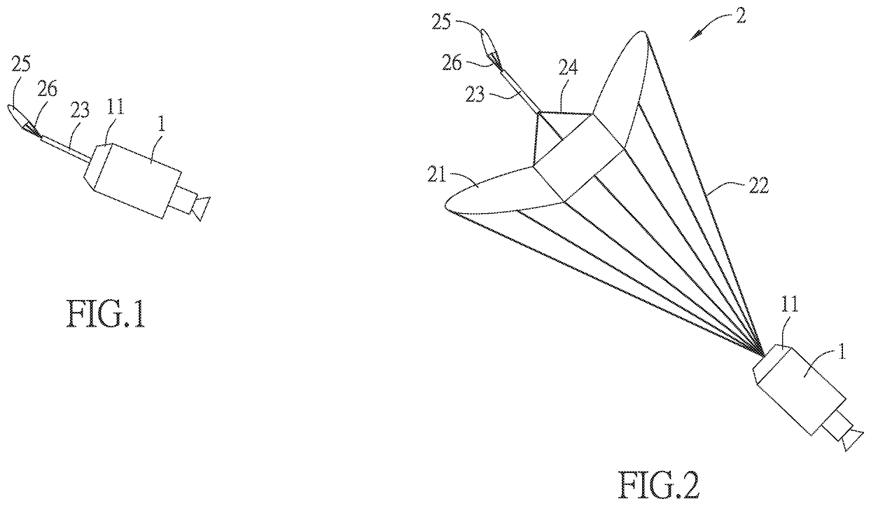

Please refer to FIGS. 1 and 2, illustrating the process of releasing a drogue parachute system 2 from a spacecraft 1 according to an embodiment of the present invention. The drogue parachute system 2 is suitable to be disposed to the spacecraft 1. The drogue parachute system 2 includes a housing (not shown), a first parachute 21, a first set of connection lines 22, an extension device 23, a second set of connection lines 24, a second parachute 25 and a third set of connection lines 26. The housing has an inner space for accommodating the first parachute 21, the first set of connection lines 22, the extension device 23, the second set of connection lines 24, the second parachute 25 and the third set of connection lines 26, and is disposed to a payload 11 of the spacecraft 1, for example.

Each connection line of the first set of connection lines 22 includes two opposite ends respectively connected to the payload 11 and the first parachute 21. Each connection line of the second set of connection lines 24 includes two opposite ends respectively connected to the first parachute 21 and the extension device 23. Each connection line of the third set of connection lines 26 includes two opposite ends respectively connected to the extension device 23 and the second parachute 25. The first, second and third sets of connection lines are made of at least KEVLAR fiber.

At least a part of the extension device 23 is flexible and is a lightweight passive extension teleport so that it is easy to receive the extension device 23 into the housing. The extension device 23 is tube-shaped and includes an inner space (not shown) for accommodating the second parachute 25 and the third set of connection lines 26.

In operation, before the spacecraft 1 enters its reentry flight, the drogue parachute system 2 is released from the payload 11 by the following steps: (1) pushing out the extension device 23 from the housing, as shown in FIG. 1; (2) releasing the second parachute 25 and the third set of connection lines 26 from the extension device 23, as shown in FIG. 1; and (3) releasing the first parachute 21, the first set of connection lines 22 and the second set of connection lines 24 from the housing, and inflating the first parachute 21 with gas, as shown in FIG. 2. The reentry flight can be initiated by the deorbiting maneuver of the spacecraft 1.

In the process of releasing the drogue parachute system 2 except the housing, the releasing of the extension device 23 is prior to the releasing of the second parachute 25 so that the third set of connection lines 26 is possibly prevented from fouling each other and entangling with the spacecraft 1. Moreover, the second parachute 25 is smaller than the first parachute 21, so as to serving as a secondary drogue chute for assisting in the opening of the first parachute 21 serving as a primary drogue chute. In the opening state of the second parachute 25, a distance between a periphery of the second parachute 25 and the spacecraft 1 is shorter than a distance between a center of the second parachute 25 and the spacecraft 1.

When the first parachute 21 fully opens, the second set of connection lines 24 pulls on the first parachute 21 and the first set of connection lines 22 supports the first parachute 21, so that the first parachute 21 fully deployed possibly maintains its reverse umbrella shape during the descending of the spacecraft 1. In the opening state of the first parachute 21, a distance between a periphery of the first parachute 21 and the spacecraft 1 is longer than a distance between a center of the first parachute 21 and the spacecraft 1. Through the opened first parachute 21 as an aeroshell, the spacecraft 1 is possibly slowed down gradually when passing through the thin-air region of the reentry flight. When the spacecraft 1 reaches the denser part of the atmosphere, the flight speed of the spacecraft 1 has already become low enough. In this way, there would be no aerothermal heating imposed on the spacecraft 1 throughout the reentry flight, and the spacecraft 1 possibly returns to the earth surface safely.

Although the forgoing embodiment is exemplarily described based on a case of the housing disposed in the payload 11, the present invention is not limited to this example. In other embodiments, the housing containing the first parachute 21, the first set of connection lines 22, the extension device 23, the second set of connection lines 24, the second parachute 25 and the third set of connection lines 26 may be disposed in another part of the spacecraft 1 instead of the payload 11.

While we have shown and described various embodiments in accordance with the present invention, it is clear to those skilled in the art that further embodiments may be made without departing from the scope of the present invention.

1. A drogue parachute system for a spacecraft, comprising:
a first parachute;
a first set of connection lines, each comprising two opposite ends respectively connected to the first parachute and the spacecraft;
an extension device;
a second set of connection lines, each comprising two opposite ends respectively connected to the extension device and the first parachute;
a second parachute; and
a third set of connection lines, each comprising two opposite ends respectively connected to the second parachute and the extension device,
wherein the first parachute fully deployed is reverse umbrella-shaped with respect to the spacecraft.

2. The drogue parachute system according to claim 1, wherein a distance between a periphery of the first parachute in operation and the spacecraft is longer than a distance between a center of the first parachute in operation and the spacecraft.

3. The drogue parachute system according to claim 1, wherein a distance between a periphery of the second parachute in operation and the spacecraft is shorter than a distance between a center of the second parachute in operation and the spacecraft.

4. The drogue parachute system according to claim 1, wherein the extension device comprises an inner space for accommodating the second parachute and the third set of connection lines.

5. The drogue parachute system according to claim 1, further comprising a housing for accommodating the first parachute, the first set of connection lines, the second set of connection lines, the extension device, the second parachute and the third set of connection lines.

6. The drogue parachute system according to claim 1, wherein the second parachute and the third set of connection lines are released from the extension device after the extension device is pushed out from the spacecraft, and then the second set of connection lines, the first parachute and the first set of connection lines are released from the spacecraft.

7. The drogue parachute system according to claim 1, wherein at least a part of the extension device is flexible.

8. (canceled)

9. The drogue parachute system according to claim 1, wherein the second parachute is smaller than the first parachute.
